(19) United States
(12) Patent Application Publication
(10) Pub. No.: US 2001/0027801 A1
(43) Pub. Date: Oct. 11, 2001

(54) Pipe cleaner

(75) Inventor: Chung-Chih Wang, Taichung (TW)

Correspondence Address: BEYER WEAVER & THOMAS LLP, P.O. BOX 778, BERKELEY, CA, 94704-0778, US

(73) Assignee: Winbond Electronics Corp.

(21) Appl. No.: 09/765,817

(22) Filed: Jan. 19, 2001

(30) Foreign Application Priority Data
Apr. 8, 2000 (TW) 89205631

(51) Int. Cl. B08B 9/032

(52) U.S. Cl. 134/102.1; 134/111; 134/169 C

(57) ABSTRACT

The present invention relates to a pipe cleaner comprising a sprayer (2), a circulating device (3) and a gas-conducting device (4) which are used to clean cakes (100) adhered on the inner wall (10) of the exhaust pipe (1). The sprayer (2) is equipped with nozzles (20) uniformly mounted on the pipe (1) and disposed with its opening faced to the inner wall (10) of the pipe (1). The working fluid (W₁) is outputted by the nozzles (20) and flushed on the inner wall (10) of the pipe (1). The energized working fluid (W₁) worked on the inner wall (10) generates lots of bubbles and disturbing current flushing on cakes (100) adhered on the inner wall (10) of the pipe (1). With continuous fluid (W₁) flushing on cakes (100) adhered on the inner wall (10) and the gas (400) running in the pipe (1), therefore, cakes (100) adhered on the inner wall (100) of the pipe (1) can be removed away quickly.

### BACKGROUND OF THE INVENTION

1. Field of the invention

This invention relates to a pipe cleaner for removing cakes adhered on the inner wall of the exhaust pipe. In particular, this invention relates to a pipe cleaner provided with energized fluid and gas running in the pipe so as to remove cakes away quickly.

2. Description of Prior Art

The scrubber is commonly used in fab to clean cakes adhered on the inner wall of the exhaust pipe. By the scrubber rubbing on the inner wall, cakes are taken into pieces and its particle possibly spreading in the air.

To avoid the generation of the particle, the present invention is provided with a pipe cleaner by using the energized working fluid and gas flushing on cakes.

### SUMMARY OF THE INVENTION

To solve the above problem, the primary object of this invention is to provide a pipe cleaner for efficiently removing cakes off the inner wall of the exhaust pipe. The pipe cleaner comprises a sprayer, a circulating device and a gas-conducting device, wherein the sprayer is provided with nozzles mounted on the pipe and disposed with its opening faced to the inner wall of the pipe, and the circulating device is communicated between the sprayer and the pipe. The gas-conducting device is provided with gas such as nitrogen running in the pipe from the sprayer to the circulating device. As the nozzles output the working fluid, the energized working fluid can be carried away and flushing on cakes adhered on the inner wall of the pipe.

Therefore, cakes adhered on the inner wall of the pipe can be quickly removed away with the running energized fluid and gas.

### BRIEF DESCRIPTION OF THE DRAWINGS

The present invention can be more fully understood by reading the subsequent detailed description and examples with reference made to accompanying drawings in which:

FIG. 1A is a plan view showing the inner structure of a exhaust gas treatment apparatus according to the present invention.

FIG. 1B is a schematically cross-sectional plan view showing the inner structure of the sprayer (2) according to FIG. 1A.

### DETAILED DESCRIPTION OF THE PREFERRED EMBODIMENTS

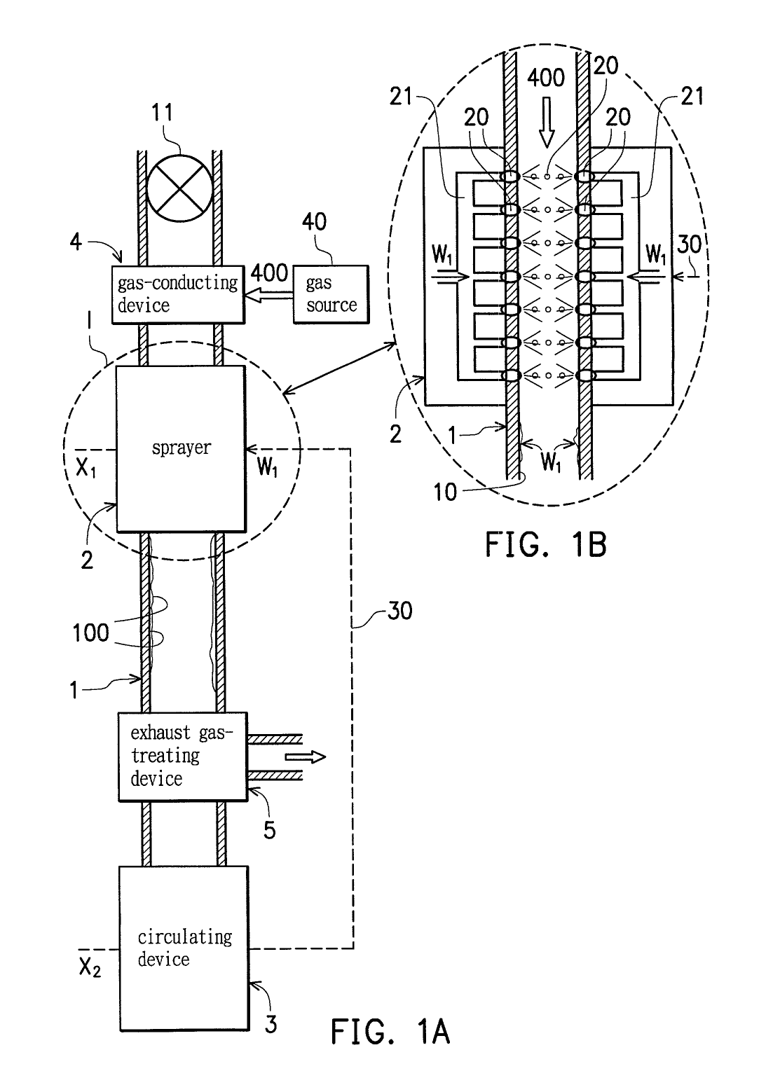

Referring to FIG. 1A, a schematically plan view shows a cake cleaning apparatus of the present invention applied on one exhaust pipe 1 of the fab. The exhaust pipe 1 controlled by a valve 11 is used to transmit the exhaust gas in the fab. The inner wall 10 of the section between the site X₁ and X₂ of the pipe 1 is piled lots of cakes 100 by the particles of the exhaust gas with time.

As shown in FIG. 1A, the cake cleaning apparatus of the present invention comprises a sprayer 2, a circulating device 3 and a gas-conducting device 4. An exhaust gas-treating device 5 placed between the site X₁ and X₂ is connected to the exhaust pipe 1 so as to deal with exhaust gas therein. As the cleaning process is being conducted, the valve 11 has to be closed.

The sprayer 2 and the circulating device 3 are respectively communicated with the pipe 1 and located at the site X₁ and X₂ thereof, and the sprayer 2 and the circulating device 3 are communicated with each other along the dotted line 30. The gas-conducting device 4, supplied with the working gas 400 such as nitrogen from gas source 40, is communicated with the pipe 1 and located between the valve 11 and the sprayer 2, i.e. located at the upstream of site X₁ and X₂ of the pipe 11. The working gas 400 is forced flowing along the pipe 1 and sequentially passing through the sprayer 2, the exhaust gas-treating device 5 and the circulating device 3. The working fluid W₁ such as clean water is circulated between the sprayer 2 and the circulating device 3 along the pipe 1 (only the section between site X₁ and X₂ thereof) and the line 30. The waste gas flowing from the sprayer 2 is then be expelled out by the exhaust gas-treating device 5.

FIG. 1B demonstrates a schematically cross-sectional plan view concerned about the enlarged inner structure of the sprayer 2 from the dotted circle line I of FIG. 1A. The sprayer 2 comprises a plurality of nozzles 20 mounted on the pipe 1 and disposed with its opening faced to the inner wall 10 of the pipe 1, and each of them is connected to a manifold pipe 20. The working fluid W₁ is outputted by the nozzles 20 and flushed on the inner wall 10 of the pipe 1. The energized working fluid W₁ worked on the inner wall 10 generates lots of bubbles and disturbing current flushing on cakes 100 adhered on the inner wall 10 of the pipe 1. Then, the polluted fluid W₂ is received and filtered by the circulating device 3 and then pumped into the sprayer 2 along the line 30 for reuse.

With continuous fluid W₁ flushing on cakes 100 with the gas 400 passing through the pipe 1, therefore, cakes 100 adhered on the inner wall 100 of the pipe 1 can be removed away and then the real surface of the inner wall 10 can be seen quickly.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. An apparatus for removing cakes adhered on the inner wall of pipe with working fluid, comprising:
a sprayer communicated with the pipe at one site, used to supply the working fluid flushing on said cakes; and
a circulating device communicated with the pipe at another site and said sprayer, used to filter the working fluid passing cakes and providing the filtered working fluid to said sprayer.

2. The apparatus as claimed in claim 1 further comprising a gas-conducting device that is used to provide a working gas sequentially passing through said sprayer and said circulating device along the pipe.

3. The apparatus as claimed in claim 2, wherein said sprayer comprises a plurality of nozzles mounted on the pipe, and each said nozzles has an outlet which is faced toward to the inner wall of the pipe.

4. The apparatus as claimed in claim 3, wherein the working fluid is water, and the working gas is nitrogen.

5. The apparatus as claimed in claim 4, wherein a valve is mounted on the pipe.

6. An apparatus for removing cakes adhered on the inner wall of pipe with working fluid, comprising:
a sprayer communicated with the pipe at one site, used to supply the working fluid flushing on said cakes;
a circulating device communicated with the pipe at another site and said sprayer, used to filter the working fluid passing cakes and providing the filtered working fluid to said sprayer; and
a gas-conducting device communicated with the pipe, used to provide a working gas sequentially passing through said sprayer and said circulating device along the pipe.

7. The apparatus as claimed in claim 6, wherein said sprayer comprises a plurality of nozzles mounted on the pipe, and each said nozzles has an outlet which is faced toward to the inner wall of the pipe.

8. The apparatus as claimed in claim 7, wherein the working fluid is water, and the working gas is nitrogen.

9. The apparatus as claimed in claim 8, wherein a valve is mounted on the pipe.

10. An apparatus for removing cakes adhered on the inner wall of pipe with working fluid, comprising:
a gas resource for providing working gas;
a sprayer communicated with the pipe at one site, provided with a plurality of nozzles used to spray with the working fluid flushing on said cakes;
a circulating device communicated with the pipe at another site, used to filter said cake of the working fluid and pump the filtered working fluid to said sprayer for circulation; and
a gas-conducting device communicated with the pipe, used to provide the working gas sequentially passing through said sprayer and said circulating device along the pipe.

11. The apparatus as claimed in claim 10, wherein each said nozzles has an outlet which is faced toward to the inner wall of the pipe.

12. The apparatus as claimed in claim 11, wherein the working fluid is water, and the working gas is nitrogen.

13. The apparatus as claimed in claim 12, wherein a valve is mounted on the pipe.
